(19) United States
(12) Patent Application Publication
(10) Pub. No.: US 2026/0067738 A1
(43) Pub. Date: Mar. 5, 2026

(54) SYSTEMS AND METHODS FOR MULTI-LINK TRAFFIC CONTROL

(71) Applicant: Cox Communications, Inc., Atlanta, GA (US)

(72) Inventor: Carol Ansley, Atlanta, GA (US)

(21) Appl. No.: 19/319,127

(22) Filed: Sep. 4, 2025

Related U.S. Application Data
(60) Provisional application No. 63/690,559, filed on Sep. 4, 2024.

(51) Int. Cl. H04W 28/02; H04W 28/06; H04W 72/0446

(52) U.S. Cl. CPC H04W 28/0205; H04W 28/06; H04W 72/0446

(57) ABSTRACT

An example access point includes a processor; and a memory having computer-executable instructions stored thereon that, when executed by the processor, cause the processor to manage assignment of AIDs, by: receiving a set of frames, where each frame of the plurality of frames is associated with a respective station and a respective first AID; selecting a set of frames associated with at least one station and respective AID from the set of frames for transmission during a period of transition; and associating the frames of the set of frames during the transition period to the respective station and a new AID.

### CROSS-REFERENCE TO RELATED APPLICATIONS

This application claims the benefit of U.S. provisional Ser. No. 63/690,559, filed on Sep. 4, 2024, and titled “SYSTEMS AND METHODS FOR MULTI-LINK TRAFFIC CONTROL,” the disclosure of which is expressly incorporated herein by reference in its entirety.

### BACKGROUND

Wireless networking includes the use of various computing devices to access services, including voice, audio, and video data services, over a wireless network such as a Local Area Network (LAN) of a home or business. Access Points (APs) can be used to provide Radio Frequency (RF) links over wireless channels for other radio-capable devices, such as smartphones, tablets, laptops, wearables, IoT, etc. to be able to access a Wide Area Network (WAN). When an AP and a device are in communication, that state is called association, and the AP and the device are said to be associated. In the process of an association, a device is assigned an Association ID (AID). The AID may be used directly in messages or indirectly as an index into a bitmap or other like indirect reference structures.

Wireless networking standards define the relationships between network components including APs and devices (also referred to as “stations”) that are associated with the APs. Networks use packets of data that are transmitted as part of data frames. The frames can define the structure of the transmitted information, and be used for routing data from an access point to a destination.

### SUMMARY

In some aspects, implementations of the present disclosure include an access point (AP) including: a processor; and a memory having computer-executable instructions stored thereon that, when executed by the processor, cause the processor to manage assignment of AIDs, by: receiving a plurality of frames, wherein each frame of the plurality of frames is associated with a respective station and a respective first AID; selecting a set of frames associated with at least one station and respective AID from the plurality of frames for transmission during a period of transition; and associating the frames of the set of frames during the transition period to the respective station and a new AID.

In some aspects, implementations of the present disclosure include an access point, wherein the memory contains further computer-executable instructions that cause the processor to: select a set of non-transition frames from the plurality of frames; and insert an indicator into the non-transition frames, wherein the indicator indicates that the frame is a frame using an old AID.

In some aspects, implementations of the present disclosure include an access point, wherein the indicator includes a flag.

In some aspects, implementations of the present disclosure include an access point, wherein the flag includes a bit of an element of the frame.

In some aspects, implementations of the present disclosure include an access point, wherein the processor contains further computer-executable instructions that cause the processor to determine where to insert the indicator in each frame of the set of non-transition frames.

In some aspects, implementations of the present disclosure include an access point, wherein the processor contains further computer-executable instructions that cause the processor to select the set of frames by selecting frames that are not part of a continuing transaction.

In some aspects, implementations of the present disclosure include an access point, wherein selecting the set of frames includes selecting frames that are part of a continuing transaction.

In some aspects, implementations of the present disclosure include an access point (AP) including: a processor; and a memory having computer-executable instructions stored thereon that, when executed by the processor, cause the processor to manage assignment of AIDs, by: deriving a first set of AIDs corresponding to a set of network devices prior to a transition; deriving a second set of AIDs corresponding to the set of network devices after the transition; determining, based on the first set of AIDs and the second set of AIDs, that at least one AID of the first set of AIDs is also in the second set of AIDs; and configuring a message based on the determination that at least one AID of the first set of AIDs is also in the second set of AIDs.

In some aspects, implementations of the present disclosure include an access point, wherein the processor is configured to disallow AID 11 messaging based on the determination that at least one AID of the first set of AIDS is also in the second set of AIDs.

In some aspects, implementations of the present disclosure include an access point or claim 9, wherein the processor is configured to set a marker bit in the message, and wherein the marker bit indicates whether the message uses an AID from the first set of AIDs or the second set of AIDs.

In some aspects, implementations of the present disclosure include a method of managing an epoch transition of a wireless network, the method including: receiving a plurality of frames, wherein each frame of the plurality of frames is associated with a respective station and a first respective AID; selecting a set of frames associated with at least one station and respective AID from the plurality of frames for transmission during a transition period; and associating the frames of the selected frames to the respective station and a new new AID.

In some aspects, implementations of the present disclosure include a method, further including selecting a second set of frames from the plurality of frames during a time of transition; and inserting an indicator into the selected frames, wherein the indicator indicates that the frames are associated with an old AID.

In some aspects, implementations of the present disclosure include a method, wherein the indicator includes a flag.

In some aspects, implementations of the present disclosure include a method, wherein the flag includes a bit of an element of the frame.

In some aspects, implementations of the present disclosure include a method, further including determining where to insert the indicator in each frame of the set of frames associated with old AIDs.

In some aspects, implementations of the present disclosure include a method, further including selecting the set of frames associated with new AIDS by selecting frames that are not part of a continuing transaction.

In some aspects, implementations of the present disclosure include a method, wherein selecting the set of frames associated with old AIDs includes selecting frames that are part of a continuing transaction.

In some aspects, implementations of the present disclosure include a method of managing an epoch transition of a wireless network, the method including: deriving a first set of AIDs corresponding to a set of network devices prior to a transition; deriving a second set of AIDs corresponding to the set of network devices after the transition; determining, based on the first set of AIDs and the second set of AIDs, that at least one AID of the first set of AIDs is also in the second set of AIDs; and configure a message based on the determination that at least one AID of the first set of AIDs is also in the second set of AIDs.

In some aspects, implementations of the present disclosure include a method, further including disallowing AID 11 messaging based on the determination that at least one AID of the first set of AIDS is also in the second set of AIDs.

In some aspects, implementations of the present disclosure include a method or claim 19, further including setting a marker bit of an AID of the message, and wherein the marker bit indicates whether the message uses an AID from the first set of AIDs or the second set of AIDs.

In some aspects, implementations of the present disclosure include a computer readable medium having instructions stored therein, wherein execution of the instructions by a processor, causes the processor to: receive a plurality of frames, wherein each frame of the plurality of frames is associated with at least one station and a respective AID; select a set of frames associated with at least one station and respective AID from the plurality of frames for transmission during a time of transition; and associate the the selected frames to the same respective station and a new AIDs.

In some aspects, implementations of the present disclosure include a computer readable medium having instructions stored therein, wherein execution of the instructions by a processor, causes the processor to: receive a first set of AIDs corresponding to a set of network devices prior to a transition; receive a second set of AIDs corresponding to the set of network devices after the transition; determine, based on the first set of AIDs and the second set of AIDs, that at least one AID of the first set of AIDs is also in the second set of AIDs; and configure a message based on the determination that at least one AID of the first set of AIDs is also in the second set of AIDs.

In some aspects, implementations of the present disclosure include a method of managing an epoch transition of a wireless network, the method including: receiving by an access point a request for a succession of messages; determining that said succession will continue across a epoch boundary, wherein each epoch has a set of station identification parameters, refusing the request for the succession of messages.

In some aspects, implementations of the present disclosure include. The method wherein the succession of messages included a channel sounding sequence.

In some aspects, implementations of the present disclosure include a method wherein the succession of messages includes a trigger frame and responses.

In some aspects, implementations of the present disclosure include a method wherein the trigger frame includes a Multi-STA BlockAck.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Media Access Control (MAC) address rotation and association ID (AID) rotation;

FIG. 2 is an illustration of a transition between an existing configuration and a new configuration of a network, according to embodiments of the present disclosure;

FIG. 3 is a flow chart of an example method for managing AID transitions, according to embodiments of the present disclosure.

FIG. 4A illustrates an example diagram of an AID, according to embodiments of the present disclosure;

FIG. 4B illustrates an example diagram of a message including an AID, according to embodiments of the present disclosure;

FIG. 5 is a block diagram of a computing device;

FIG. 6 is a flow chart of an example method for managing AID transitions, according to embodiments of the present disclosure; and

FIG. 7 illustrates a method of associating frames to a station and a new AID, according to embodiments of the present disclosure.

### DETAILED DESCRIPTION

### Overview

Embodiments of the present disclosure include improvements to networking systems, including networking systems that improve privacy and security. Example embodiments include systems, devices, and methods that can allow for improved privacy and security, while maintaining high levels of network performance.

The Institute of Electrical and Electronics Engineers (IEEE) 802.11 standard defines protocols, procedures, and communication parameters to use for wireless networking, such as various Wi-Fi operational configurations. Current IEEE 802.11 standards require that a device or Station (STA) use the same Media Access Control (MAC) address for the length of its association with an AP. Some devices obscure their MAC addresses by changing their MAC addresses randomly between associations. However, once associated with an AP, the associated device is required to maintain the same MAC address during the association. Otherwise, the device will be forced to re-associate each time it changes its MAC address.

Wi-Fi operational privacy includes significant vulnerabilities. For example, MAC address information is readily available to surveil from unsuspecting device users once a device's wireless networking interface is activated. Data about the identity and movements of Wi-Fi device holders has been readily available because the initial design of Wi-Fi did not anticipate its use and the close linkage that could be extracted from a person's devices with a person's activities.

Currently, third party snoopers can use different eavesdropping devices to collect station information from Over The Air (OTA) traffic. A third party snooper can use collected station information to determine where a device user may be located by monitoring an AP and MAC addresses that associate with the AP.

Association IDs (AIDs) are used in Wi-Fi systems to identify STAs that are associated with an AP. AIDs are used as part of data frames transmitted between the STA and the AP to identify the STA. Therefore, the length of the AIDs impacts the performance of the Wi-Fi system, and efficient usage of the AID by the Wi-Fi system benefits the performance of the Wi-Fi systems by reducing the amount of data that needs to be transmitted in each frame. AIDs for Multi-Link Devices (MLD) are restricted to the range of 0 to 2007. When multiple specific MLDs are addressed in a single message, a bit map with 2008 positions can be used to efficiently indicate which devices are being selected. A message could include the entire bit map, or the message could indicate a specific range of AIDs that are included. For example, a bit map could include 16 bits that represent AIDs 16-31. Embodiments of the present disclosure can more efficiently use AIDs (e.g., the limited number of bits within an AID) to manage transitions between network states and/or associate additional devices with an AP. Additionally, aspects of the present disclosure provide mechanisms to hide, obscure, alter, limit, etc. an amount of information that is available to third parties when wireless devices communicate. Transitions between network states can be used to assign new AIDs, MAC addresses, and/or any other identifier for an STA. Assigning new identifiers to STAs can prevent tracking based on identifiers (e.g., tracking a device based on a unique AID that is associated with that device over time).

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

As described above, Multi-Link Operation (MLO) communication environments may include an AP MLD and one or more STA MLDs. An AP MLD is made up of affiliated APs and a non-AP (STA) MLD is made up of affiliated STAs. The AP MLD and STA MLD control the MLD MAC address for the MLD. The affiliated APs and affiliated STAs control the MAC addresses that are use in the individual links that are part of the MLD. An MLO communication environment can also use an external MAC address for group messages and broadcasting events. An advantageous way to change the MAC addresses while everything is set up and associated, is for all of the affiliated APs and their associated STAs to change all OTA MAC addresses with a single coordinated change.

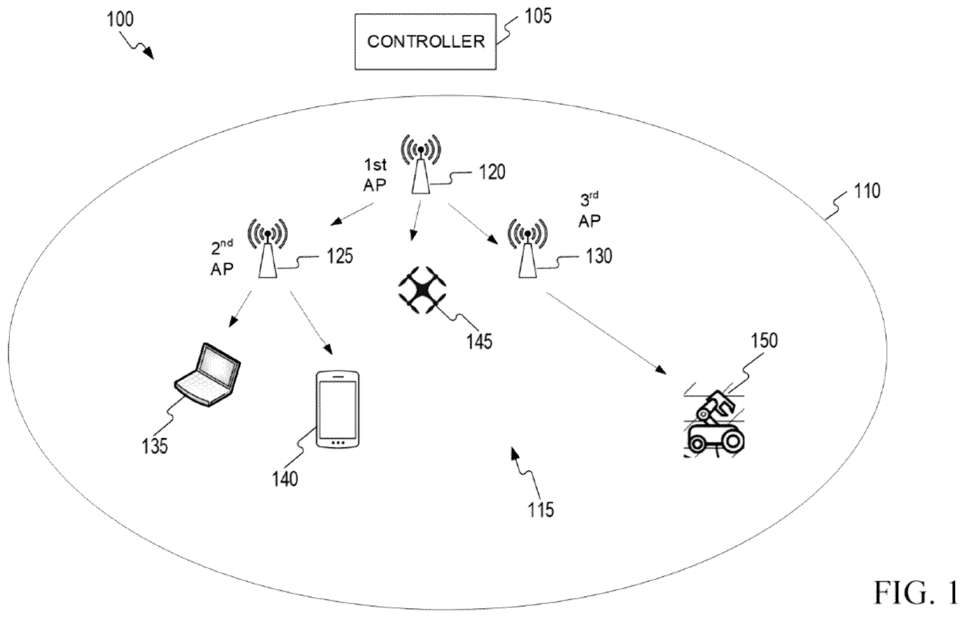

FIG. 1 shows an operating environment 100 including STAs and APs according to embodiments of the present disclosure. As shown in FIG. 1, operating environment 100 may comprise a controller 105 and a coverage environment 110. Coverage environment 110 may comprise, but is not limited to, a Wireless Local Area Network (WLAN) comprising a plurality of STAs 115 (stations). The plurality of STAs 115 may include a plurality of APs (access points) and a plurality of client devices. At any given time, any one of the plurality of STAs 115 may comprise an Initiating Station (ISTA) or a Responding Station (RSTA). The plurality of APs may provide wireless network access (e.g., access to the WLAN) for the plurality of client devices. The plurality of APs may comprise a first AP 120, a second AP 125, and a third AP 130. Each of the plurality of APs may be compatible with specification standards such as, but not limited to, the Institute of Electrical and Electronics Engineers (IEEE) 802.11 specification standard for example.

The plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, an Unmanned Aerial Vehicle (UAV), or other similar microcomputer-based device. In the example shown in FIG. 1, the plurality of client devices may comprise a first client device 135 (e.g., a laptop computer), a second client device 140 (e.g., a smart phone), a third client device 145 (e.g., a drone), and a fourth client device 150 (e.g., an ATV).

Controller 105 may comprise a Wireless Local Area Network controller (WLC) and may provision and control operating environment 100 (e.g., the WLAN). In some embodiments of the disclosure, controller 105 may configure information for operating environment 100 in order to provide MAC address rotation consistent with embodiments of the disclosure.

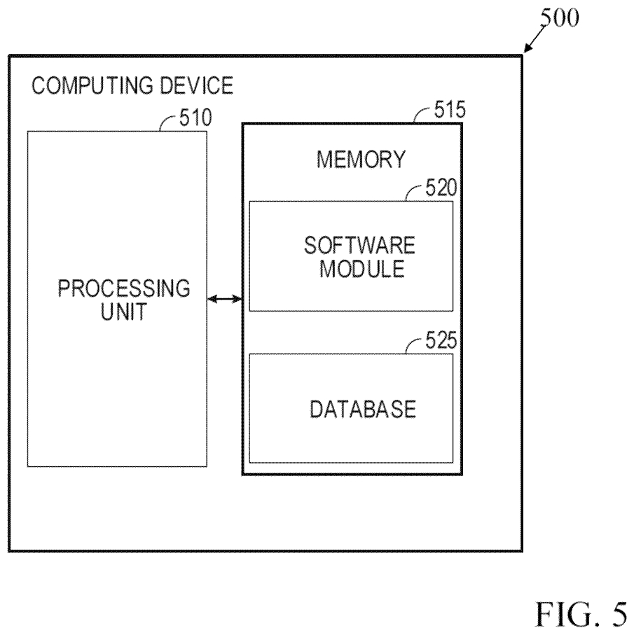

The elements described above of operating environment 100 (e.g., controller 105, first AP 120, second AP 125, third AP 130, first client device 135, second client device 140, third client device 145, and fourth client device 150) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 5, the elements of operating environment 100 may be practiced in a computing device 500.

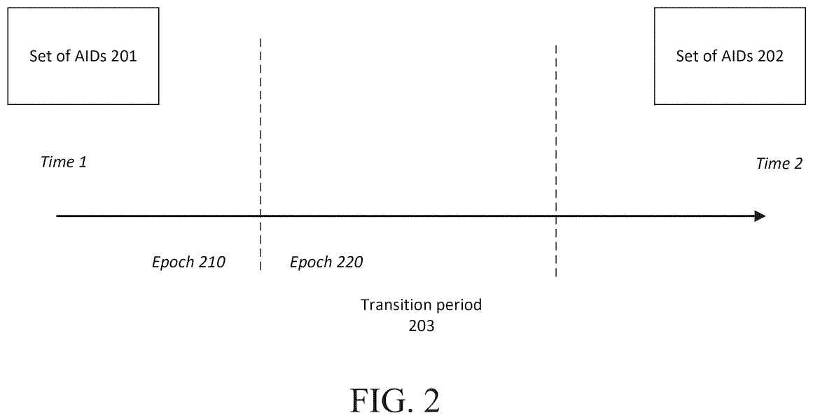

FIG. 2 is a diagram showing the usage over time of AIDs in a subject system. A set of AIDs 201 is established and used until time T1. The time from when the set of AIDs 201 is established and distributed for use until time T1 may be called epoch 210. Then a new epoch 220 begins with the commencement of a transition period 203. During the transition period 203, an AP can send traffic with new AIDs from the AID set 202 and accept traffic with AIDs from set 201 or 202. A STA or non-AP MLD can send new traffic with a corresponding new AID from set 202, but can alternatively use the previous AID from set 201 for buffered traffic or ongoing transactions that were begun with that AID. An example of an ongoing transaction could be a frame that was initially transmitted before the transition period but was not received correctly and must be retransmitted. At time T2, the AP/AP MLD and the STA/non-AP MLD can be configured to not transmit and/or receive traffic using AIDs from set 201 and can be configured to only use the new AIDs from set 202. For specific messages and protocol exchanges, the transmitting and receiving devices can optionally have incomplete synchronization and/or may still be trying to complete a protocol exchange that began before time T1. In those cases, additional protocol definitions can be used to prevent data from being lost and/or network time wasted by retrying protocol exchanges.

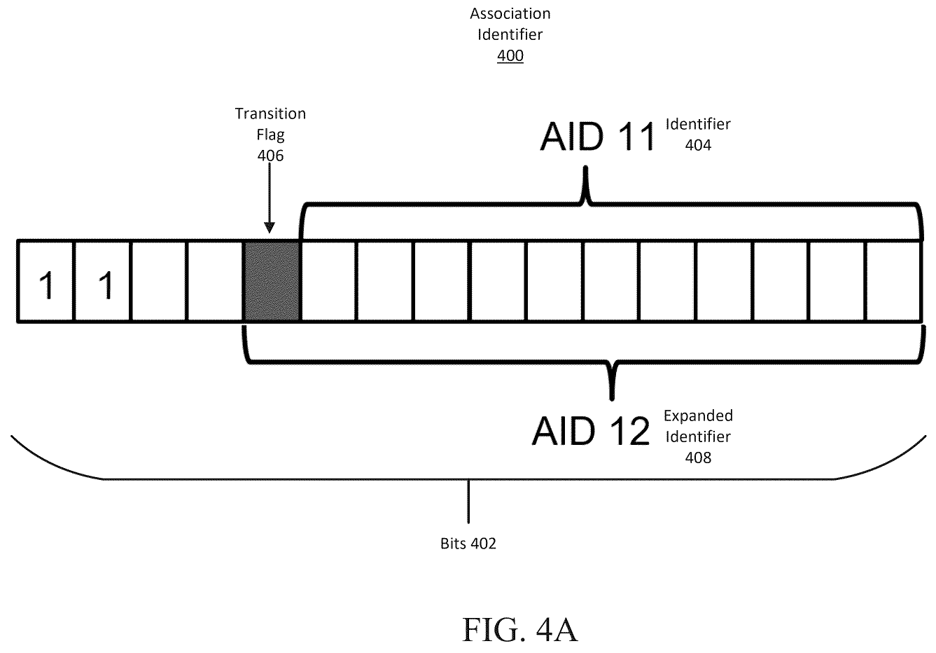

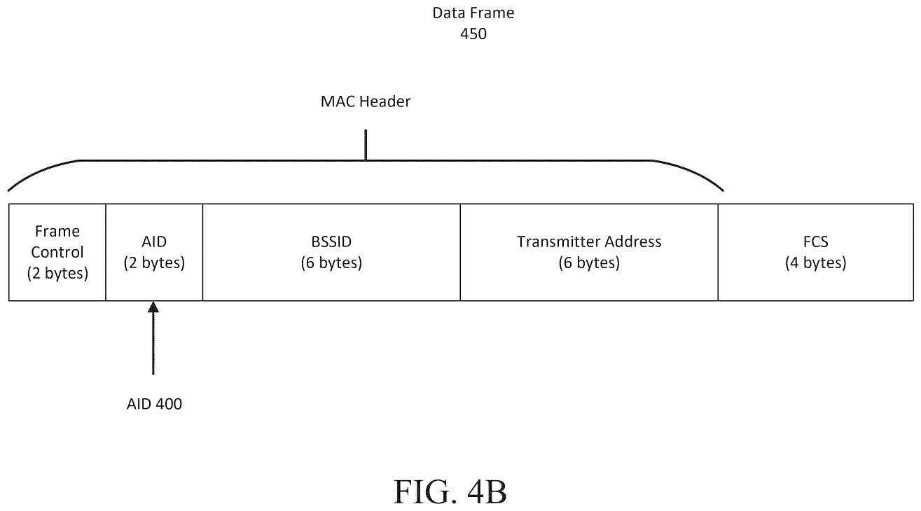

FIG. 4A illustrates an example AID 400 that can be part of a set of association identifiers 201 or 202 described with reference to FIG. 2. The AID 400 includes 16 bits 402. The AID 400 can be truncated to an identifier 404. The identifier 404 can include 11 bits of the 16 bits 402, as shown in FIG. 4A. An 11-bit identifier 404 is limited to 2048 total combinations of numbers. In an example wireless protocol, the 11-bit identifier 404 may be limited to 2007 unique numbers. When the AID is used by a station to associate with an access point (e.g., as shown in FIG. 2), the 11-bit identifier 404 can limit the access point to only about 2007 connected devices. Alternatively, the AID may be truncated to 12 bits or 13 bits for ease of use.

Embodiments of the present disclosure include a transition flag 406 that can optionally be implemented using a single bit of the 16 bits 402. The transition flag 406 can be a bit of the 16 bits 402 that is not required by the AID 400 in a particular message, and/or is also not part of the 11-bit identifier 404. For example, in FIG. 4A, the transition flag 406 can be used to indicate that an AID 201 is a part of existing AID set 201, or a new AID set 202 during the transition period 203 (as shown in FIG. 2). The first access point 120 can use the transition flag 406 to manage the transition between the existing AID 210a and the new AID 210c. Managing the transition 230 between the existing AID 210a and the new AID 210c can include, for example, clearing out a buffer in the first access point 120 by completing transmissions using existing AIDs 210a, and creating new transmissions using new AIDs 210c.

Embodiments of the present disclosure improve the performance of access points using AIDs 400 by making better use of the bits allocated to the AID. FIG. 4B illustrates an example data frame 450 including an AID 400. The example data frame 450 allocates two bytes to the AID (i.e., the 16 bits shown in FIG. 4A). Because the data frame 450 only allocates 16 bits to the AID, it may be impractical to expand the length of the data frame 450 without altering the system that transmits and receives the data frame 450 (e.g., the operating environment 100 shown in FIG. 1, with any number of access points and stations). Moreover, because the AID 400 is included in the data frame 450, the length of the AID 400 cannot be increased without interfering with other parts of the data frame 450. Embodiments of the present disclosure therefore improve the operation of systems using AIDs by increasing the capabilities of access points and stations using AID 400 while avoiding increasing the size of the frame 450 and/or AID 400 and incurring the additional memory and performance costs of larger frame 450 and/or AID 400.

It should be understood that the methods herein can be used with an AID of any length, and that the 16 bits, 11 bits, and 12 bits shown in FIG. 4A are only non-limiting examples of specific numbers of bits that can be used, and that in some embodiments the transition flag can include multiple bits. Likewise, it should be understood that the particular arrangement of bits within the AID 400 is intended only as a non-limiting example, so that, for example, the identifier 404 and/or transition flag 406 can comprise different positions in the AID 400. In other instantiations, other bits within the AID Information element or AID field may be reclaimed for use as transition flags.

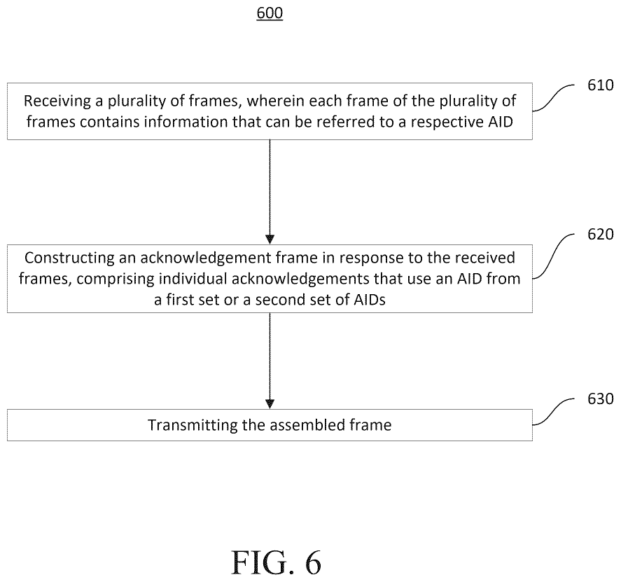

With reference to FIG. 6, implementations of the present disclosure include methods of operating access points during transitions from one epoch to another epoch in a network (e.g., methods that can be implemented in the operating environment 100 described in FIG. 1). In particular (as described in greater detail above) transitions from one epoch to another epoch can require re-assignment of AIDs so that some or all of the stations of a network have different AIDs before and after the epoch transitions. In other words, the transition from one epoch to another epoch involves re-assigning AIDs.

During operation, access points can buffer frames (e.g., data frames) to be transmitted to the stations of the network. For example, buffering is performed when stations are asleep so that data frames are not transmitted to stations that are not configured to receive the frames. Mobile devices can optionally also buffer frames. For example, a device may receive a burst of data frames from an application that are generated faster than the mobile device can transmit them to the AP. Additionally, for busy networks, an access point can acknowledge the reception of multiple frames from multiple transmitters with a minimum of transmitted frames. Some frames do not require buffering. For example, control frames like a PS Poll (“power save poll”) can be transmitted at any time.

Buffered frames can include station identification information indicating the station that the buffered frames are to be transmitted to. Because a station's AID and other identification information can change during an epoch transition, the AIDs associated to stations with frames that were buffered before the transition can be incorrect after the epoch transition. Because the AID is used to route frames to the correct station of the network, changing AIDs while frames are buffered can prevent the buffered frames from being received by the intended station.

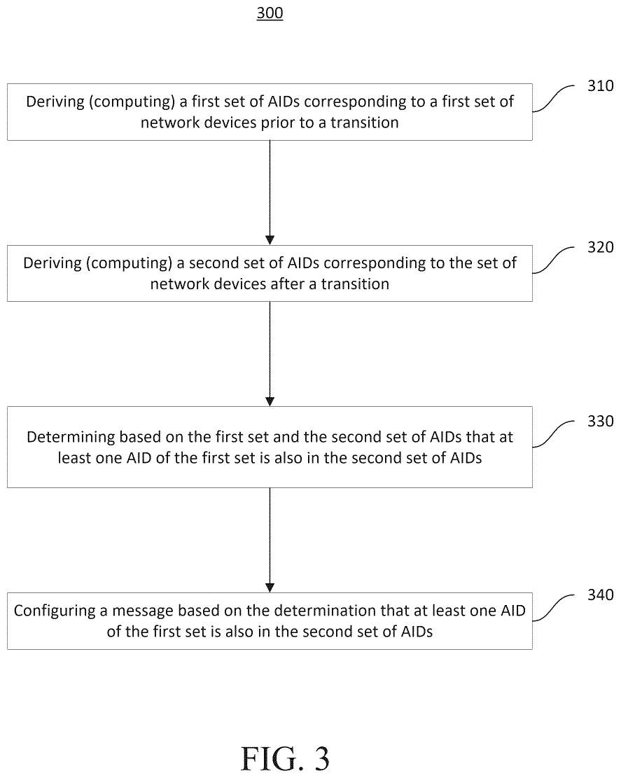

Implementations of the present disclosure include methods to improve access points managing epoch transitions in wireless networks. In particular, implementations of the present disclosure include improvements to managing epoch transitions including buffered and/or unbuffered frames to overcome the limitations of FIGS. 3 and 6 illustrate example methods (300 and 600, respectively) according to the present disclosure. Methods 300, 600 can be implemented using first AP 120 that may be embodied by a computing device 500 as described in more detail herein with respect to FIGS. 1 and 5. However, methods 300, 600 may be implemented using any of controller 105 or plurality of STAs 115. The methods 300, 600 can be implemented using access points of a network to manage epoch transitions of the network. It should be understood that the methods 300, 600 can be implemented by a system with any number of access points, as part of a device (e.g., a single access point configured to implement the method), as a computer-implemented method, and/or as a computer-readable medium.

With reference to FIG. 6, an example method 600 is shown according to some implementations of the present disclosure. The example method shown in FIG. 6 can manage the assignment of AIDs during a transition by selecting frames that are not affected by the epoch transition (i.e., “transition frames”) and then managing the transition frames and non-transition frames separately so that the non-transition frames (e.g., buffered frames) are correctly routed during the epoch transition. An example of a buffered frame that can be used in networks is a Multi STA BlockAck frame that acknowledges multiple data frames using a single transmission.

At step 610, the method includes receiving a plurality of frames, where each frame can include information that can be referred to a respective AID.

At step 620, the method includes constructing an acknowledgement frame in response to the received frames, the acknowledgment frame including individual acknowledgements that use an AID from a first set or a second set of AIDs.

At step 630, the method includes transmitting an assembled frame.

Optionally, the method can include managing the non-transition frames. The non-transition frames can include frames that are buffered (e.g., data frames), or frames that are related to the buffering process. The method can further include inserting indicators into the non-transition frames to indicate whether the non-transition frames are using an old AID and/or a new AID. The indicator can be a “flag’ or other bit of a message. As described with reference to FIGS. 4A and 4B, above, data frames and/or parts of data frames can include unused bits that can be toggled as flags. As described herein, an unused bit is a bit that is present in a frame, but not allocated to an element of the frame. In other words, implementations of the present disclosure allow for previously unused bits in frames to be used as flags to manage AID transitions efficiently without increasing the overall size of frames, by inserting information about the AID transitions into those previously unused bits.

Additionally, the present disclosure contemplates that different bits can be used in different frames, and that the method can include determining what bit to use as an indicator of the AID status (e.g., new vs. old) by determining what frame is being transmitted in the network, and identifying what unused bits are present in the frame and therefore available to use as an indicator/flag.

With reference to FIG. 3, an example method 300 is shown according to some implementations of the present disclosure. The example method 300 shown in FIG. 3 can manage the assignment of AIDs during a transition by determining whether AIDs are reused between stations before and after an epoch transition, and managing the transition based on whether AIDs are reused.

At step 310 the method includes deriving a first set of AIDs defining a first set of network devices prior to the transition. For example, the first set of AIDs can correspond to some or all of the stations of a network that communicate with an access point.

At step 320 the method can include deriving a second set of AIDs for the set of network devices after the transition. As described in detail above, an epoch transition can involve re-assigning AIDs to the stations of a network, so that some or all of the network devices have different respective AIDs after the transition than before the transition. Accordingly, the second set of AIDs and the first set of AIDs may not include any of the same AIDs. However, as also described in detail above with reference to FIGS. 4A and 4B, a limitation on networks is the limited number of available AIDs that can be addressed by the 11-bit AID that is often used in network devices. Accordingly, the first set of AIDs and second set of AIDs may use the same AID to refer to different stations of the network.

At step 330 the method includes determining based on the first set and the second set of AIDs that at least one AID of the first set is also in the second set of AIDs.

At step 340 the method can include configuring a message based on the determination that at least one AID of the first set is also in the second set of AIDs. For example, step 340 the method can include using additional bits in response to determining that the second set of AIDs includes an AID from the first set of AIDs. For example, the message can be configured to use AID 12 messaging (e.g., adding a bit to the message to allow expand the range of AIDs and therefore avoid reuse). Alternatively or additionally, as described with reference to FIGS. 4A and 4B, the additional bit can optionally be a status bit that indicates whether the AID is a new AID or old AID. Alternatively or additionally, the method can include disallowing the use of AID 11 messaging to prevent reused AIDs during the transition from indicating an incorrect station.

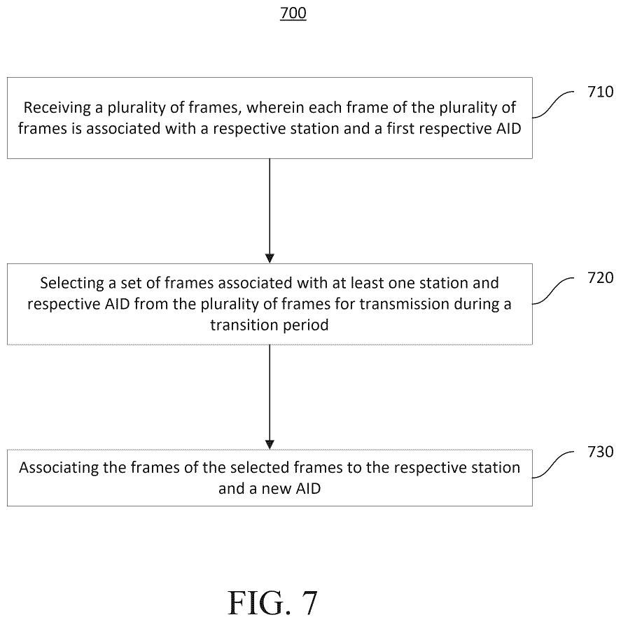

FIG. 7 illustrates a method 700 of managing epoch transitions according to implementations of the present disclosure. The methods described with reference to FIG. 7 can optionally be performed by the STAs 115 described with reference to FIG. 1 (e.g., the method can be performed by one or more access points).

At step 710, the method 700 of FIG. 7 can include receiving a plurality of frames, wherein each frame of the plurality of frames is associated with a respective station and a first respective AID At step 720, the method 700 of FIG. 7 can include selecting a set of frames associated with at least one station and respective AID from the plurality of frames for transmission during a transition period. Optionally the set of frames can be selected from the frames that are not part of a continuing transaction.

At step 730, the method 700 of FIG. 7 can include associating the frames of the selected frames to the respective station and a new AID.

Optionally, the method can further include selecting a second set of frames from the received frames during the transition and inserting an indicator into the selected frames. The indicator can indicate that the frames are associated with an old AID. The indicator can optionally be a flag (e.g., a bit within the frame). Alternatively or additionally, the old AID's can be selected by selecting frames that are part of a continuing transaction.

Alternatively or additionally, the method an include determining where to insert an indicator in each frame of the set of frames.

FIG. 5 shows computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for updating AID assignments as described above with respect to FIGS. 2-4B. Computing device 500, for example, may provide an operating environment for controller 105, first AP 120, second AP 125, third AP 130, first client device 135, second client device 140, third client device 145, and fourth client device 150. Controller 105, first AP 120, second AP 125, third AP 130, first client device 135, second client device 140, third client device 145, and fourth client device 150 may operate in other environments and are not limited to computing device 500.

Computing device 500 may be implemented as a Wi-Fi AP MLD, a tablet device, a mobile multi-link device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. An access point (AP) comprising:
a processor; and
a memory having computer-executable instructions stored thereon that, when executed by the processor, cause the processor to manage assignment of AIDs, by:
receiving a plurality of frames, wherein each frame of the plurality of frames is associated with a respective station and a respective first AID;
selecting a set of frames associated with at least one station and respective AID from the plurality of frames for transmission during a period of transition; and
associating the frames of the set of frames during the transition period to the respective station and a new AID.

2. The access point of claim 1, wherein the memory contains further computer-executable instructions that cause the processor to:
select a set of non-transition frames from the plurality of frames; and
insert an indicator into the non-transition frames, wherein the indicator indicates that the frame is a frame using an old AID.

3. The access point of claim 2, wherein the indicator comprises a flag.

4. The access point of claim 3, wherein the flag comprises a bit of an element of the frame.

5. The access point of claim 2, wherein the processor contains further computer-executable instructions that cause the processor to determine where to insert the indicator in each frame of the set of non-transition frames.

6. The access point of claim 1, wherein the processor contains further computer-executable instructions that cause the processor to select the set of frames by selecting frames that are not part of a continuing transaction.

7. The access point claim 2, wherein selecting the set of frames comprises selecting frames that are part of a continuing transaction.

8. A method of managing an epoch transition of a wireless network, the method comprising:
receiving a plurality of frames, wherein each frame of the plurality of frames is associated with a respective station and a first respective AID;
selecting a set of frames associated with at least one station and respective AID from the plurality of frames for transmission during a transition period; and
associating the frames of the selected frames to the respective station and a new AID.

9. The method of claim 8, further comprising
selecting a second set of frames from the plurality of frames during a time of transition; and
inserting an indicator into the selected frames, wherein the indicator indicates that the frames are associated with an old AID.

10. The method of claim 9, wherein the indicator comprises a flag.

11. The method of claim 10, wherein the flag comprises a bit of an element of the frame.

12. The method of claim 9, further comprising determining where to insert the indicator in each frame of the set of frames associated with old AIDs.

13. The method of claim 8, further comprising selecting the set of frames associated with new AIDS by selecting frames that are not part of a continuing transaction.

14. The method of claim 9, wherein selecting the set of frames associated with old AIDs comprises selecting frames that are part of a continuing transaction.

15. A non-transitory computer-readable medium having instructions stored therein, wherein execution of the instructions by a processor, causes the processor to:
receive a plurality of frames, wherein each frame of the plurality of frames is associated with at least one station and a respective AID;
select a set of frames associated with at least one station and respective AID from the plurality of frames for transmission during a time of transition; and
associate the selected frames to a same respective station and a new AID.

16. The non-transitory computer-readable medium of claim 15, further comprising instructions that when executed by a processor, cause the processor to:
select a second set of frames from the plurality of frames during a time of transition; and
insert an indicator into the selected frames, wherein the indicator indicates that the frames are associated with an old AID.

17. The non-transitory computer-readable medium of claim 16, wherein the indicator comprises a flag.

18. The non-transitory computer-readable medium of claim 17, wherein the flag comprises a bit of an element of the frame.

19. The non-transitory computer-readable medium of claim 16, further comprising instructions that when executed by a processor, cause the processor to: determine where to insert the indicator in each frame of the set of frames associated with old AIDs.

20. The non-transitory computer-readable medium of claim 15, further comprising instructions that when executed by a processor, cause the processor to: select the set of frames associated with new AIDS by selecting frames that are not part of a continuing transaction.
